(19) United States
(12) Patent Application Publication
(10) Pub. No.: US 2022/0383331 A1
(43) Pub. Date: Dec. 1, 2022

(54) SALES DATA PROCESSING SYSTEM AND METHOD

(71) Applicant: TOSHIBA TEC KABUSHIKI KAISHA, Tokyo (JP)

(72) Inventor: Shino NISHIKAWA, Tokyo (JP)

(73) Assignee: TOSHIBA TEC KABUSHIKI KAISHA, Tokyo (JP)

(21) Appl. No.: 17/581,241

(22) Filed: Jan. 21, 2022

(30) Foreign Application Priority Data
Jun. 1, 2021 (JP) 2021-092380

(51) Int. Cl. G06Q 30/00; G06Q 20/20; G07G 1/00; G06V 40/16; G10L 25/63

(52) U.S. Cl. CPC G06Q 30/016; G06Q 20/208; G07G 1/0045; G06V 40/174; G10L 25/63

(57) ABSTRACT

A sales data processing system includes a registration unit configured to register information of a commodity specified by information acquired by a mobile terminal as sales data, a state recognition unit configured to recognize a state of an operator of the mobile terminal based on the information acquired by the mobile terminal, in parallel with a process by the registration unit, a determination unit configured to determine whether support from a clerk is required, based on the state of the operator recognized by the state recognition unit, and a request output unit configured to output information for requesting support for the operator to a clerk terminal operated by the clerk, if the determination unit determines that the support from the clerk is required.

### CROSS-REFERENCE TO RELATED APPLICATION

This application is based upon and claims the benefit of priority from Japanese Patent Application No. 2021-092380, filed on Jun. 1, 2021, the entire contents of which are incorporated herein by reference.

### FIELD

Embodiments described herein relate generally to a sales data processing system and a method.

### BACKGROUND

In a store such as a retail store where a customer carries a commodity purchased by himself or herself from a display place, a customer who could not find a desired commodity may ask a clerk. This tends to happen, for example, if the store is large. Furthermore, the clerk may not be found even if the customer asks. In such a case, the customer is dissatisfied. Therefore, such a case causes a decrease in customer satisfaction level.

Here, a related art discloses a technology that captures a face image of a customer with a device for performing reception, analyzes the emotion of the customer based on the face image, and transmits the face image to a terminal of an opposite party. If customer's dissatisfaction can be detected, the clerk can rush to the customer who is dissatisfied and support the customer. However, in the related art, the emotion of the customer who is moving in the store cannot be recognized.

The matters described above are an example, and the customer satisfaction level decreases as a state of wanting the support of the clerk continues regardless of a business form.

### DESCRIPTION OF THE DRAWINGS

FIG. 1 is a diagram illustrating an example of a configuration of a sales data processing system according to at least one embodiment;

FIG. 2 is a diagram illustrating an example of an appearance of a cart POS;

FIG. 3 is a diagram illustrating an example of a hardware configuration of a mobile terminal;

FIG. 4 is a diagram illustrating an example of a functional configuration of the mobile terminal;

FIG. 5 is a diagram illustrating an example of a hardware configuration of a server;

FIG. 6 is a diagram illustrating an example of a functional configuration of the server;

FIG. 7 is a diagram illustrating an example of a hardware configuration of a clerk terminal;

FIG. 8 is a diagram illustrating an example of a functional configuration of the clerk terminal; and

FIG. 9 is a diagram schematically illustrating an example of a processing flow of each configuration of the sales data processing system.

### DETAILED DESCRIPTION

Embodiments provide a sales data processing system and a method that, if a customer moving through a sales floor of a retail store is in a state requiring the support of the clerk, notifies the clerk of the situation so that the clerk can provide support to the customer.

In general, according to at least one embodiment, there is provided a sales data processing system including a registration unit configured to register information of a commodity specified by information acquired by a mobile terminal as sales data, a state recognition unit configured to recognize a state of an operator of the mobile terminal based on the information acquired by the mobile terminal, in parallel with a process by the registration unit, a determination unit configured to determine whether support from a clerk is required, based on the state of the operator recognized by the state recognition unit, and a request output unit configured to output information for requesting support for the operator to a clerk terminal operated by the clerk if the determination unit determines that the support from the clerk is required.

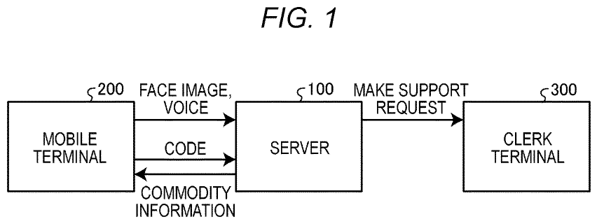

An embodiment will be described with reference to the drawings. FIG. 1 is a diagram illustrating an example of a configuration of a sales data processing system according to at least one embodiment embodiment. The sales data processing system includes a server 100, a mobile terminal 200, and a clerk terminal 300.

The mobile terminal 200 is a terminal device used by a customer who moves in a store. The mobile terminal 200 transmits a code capable of identifying a commodity to the server 100, and receives commodity information from the server 100. The mobile terminal 200 transmits a face image and voice of the customer to the server 100.

The server 100 is also called a store server or a store terminal, and is, for example, a personal computer (PC) installed in a backroom or the like of the store. The server 100 is connected to a headquarter server belonging to a headquarter that brings a plurality of stores together via a network such as a dedicated line, and can transmit and receive various data to and from the headquarter server.

The server 100 transmits information of the commodity (commodity information) specified based on the code received from the mobile terminal 200 to the mobile terminal 200. The commodity information is, for example, a price or a name. The server 100 recognizes a state of the customer based on the face image and the voice received from the mobile terminal 200. If the customer requires the support of the clerk, the server 100 transmits information indicating the support is requested to the clerk terminal 300.

The clerk terminal 300 is a terminal device used by the clerk, for example, a smartphone. If the clerk terminal 300 receives information for requesting the support for the customer from the server 100, the clerk terminal 300 notifies the clerk of the support request by displaying the information on a display device or emitting a voice through a speaker.

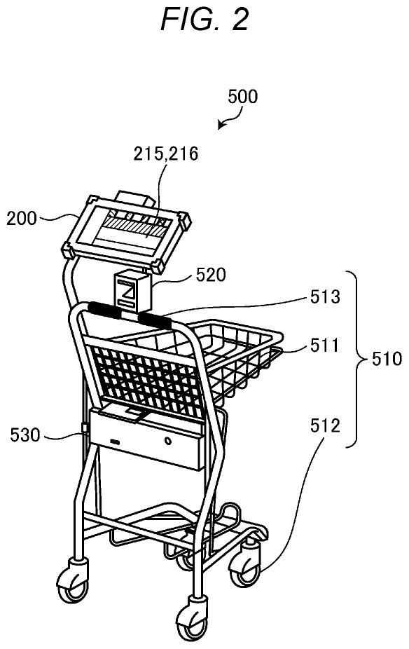

FIG. 2 is a diagram illustrating an example of an appearance of a cart POS 500. The cart POS 500 is configured with a shopping cart 510, which is used for transporting commodities purchased by the customer in a store, to which a mobile terminal 200, a scanner 520, and a battery 530 are attached.

The shopping cart 510 includes a storage portion 511, a caster portion 512, and a handle portion 513. The storage portion 511 is a basket-shaped container whose upper surface is opened, and stores the commodities to be purchased by the customer. The caster portion 512 is a plurality of wheels provided at the lower part of the legs that support the storage portion 511, and the shopping cart 510 can be moved back and forth and left and right by the caster portion 512. The handle portion 513 is a portion that the customer grips when moving the shopping cart 510.

The scanner 520 incorporates a light emitting diode (LED) that illuminates the commodity, alight receiving element such as a charge coupled device (CCD) or a complementary metal oxide semiconductor (CMOS) that receives light reflected by a code symbol attached to the commodity, a decoder that decodes the code symbol drawn by the light received by the light receiving element (both not illustrated), and the like. On one surface of the scanner 520, a reading window for emitting light from the LED to read the code symbol is provided.

If the customer stores the commodity to be purchased in the storage portion 511, the customer holds the code symbol attached to the commodity over the reading window and causes the scanner 520 to read the code symbol. The scanner 520 reads the code symbol such as a barcode and a two-dimensional code attached to the commodity. That is, by decoding the code symbol (image), a commodity code that uniquely identifies the commodity is acquired, and the commodity code is output to the mobile terminal 200.

Instead of the scanner 520, the cart POS 500 may include a hand scanner that reads the code symbol by the customer holding the hand scanner by himself or herself and bringing the hand scanner close to the code symbol attached to the commodity.

The mobile terminal 200 registers information (commodity information) of the commodity identified (uniquely specified) based on the commodity code input from the scanner 520 as sales data. The commodity is specified by the server 100 to which the commodity code is input from the mobile terminal 200. The server 100 outputs commodity information corresponding to the commodity code, that is, the price, the name (commodity name) , and the like to the mobile terminal 200.

The battery 530 supplies (feeds) power to the mobile terminal 200 and the scanner 520. Since the battery 530 is a heavy object, the battery 530 is installed as low as possible, for example, below the storage portion 511. The battery 530 is a rechargeable battery (secondary battery) such as a lithium ion battery or a nickel hydrogen battery.

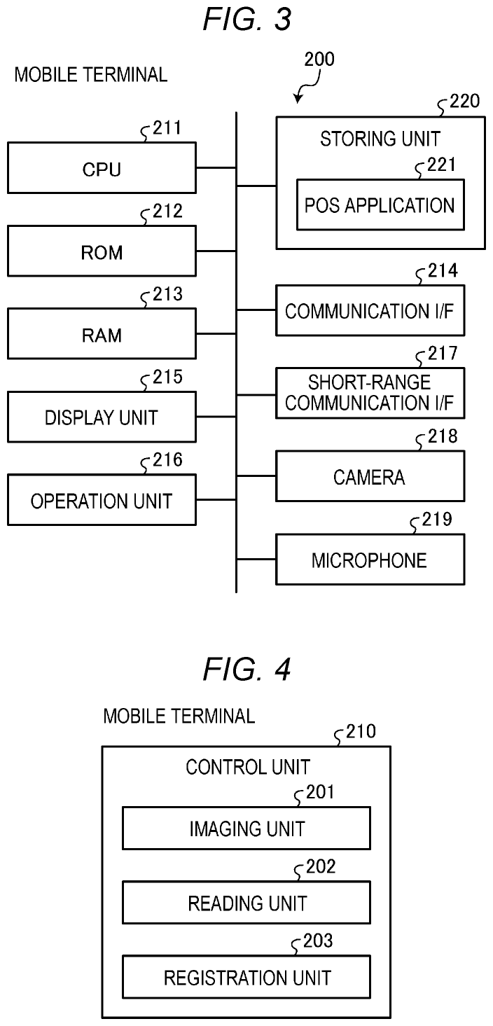

FIG. 3 is a diagram illustrating an example of a hardware configuration of the mobile terminal 200. The mobile terminal 200 includes a central processing unit (CPU) 211, a read only memory (ROM) 212, a random access memory (RAM) 213, a communication I/F (interface) 214, a display unit 215, an operation unit 216, a short-range communication I/F 217, a camera 218, a microphone 219, a storing unit 220, and the like.

The display unit 215 is a display device such as a liquid crystal display (LCD), and displays information to the operator (customer) of the mobile terminal 200. The operation unit 216 is, for example, a touch panel or the like provided while being overlapped on a display surface of the display unit 215, and receives an input operation to the mobile terminal 200 and outputs information based on the operation.

The communication I/F 214 enables communication with an external device, and mediates communication with the server 100 and the like. The short-range communication I/F 217 performs non-contact communication (short-range wireless communication) with the scanner 520 by near field communication (NFC), Bluetooth (registered trademark) , or the like. The CPU 211 controls the scanner 520 via the short-range communication I/F 217, and acquires the commodity code output by the scanner 520.

The camera 218 includes a light receiving element such as a CCD or CMOS, and converts light received by the light receiving element into an electric signal and outputs the signal. The camera 218 is provided in an outer casing of the mobile terminal 200, and images a side facing the display unit 215 and the operation unit 216. Since the display unit 215 is viewed by the operator (customer) of the mobile terminal 200, the display unit 215 faces a customer's face. That is, the captured image output by the camera 218 includes an image of the customer's face if the customer is looking at the mobile terminal 200. The captured image of the camera 218 is not required to be displayed on the display unit 215. The microphone 219 collects sound outside the mobile terminal 200, converts an input voice into an electric signal, and outputs the signal.

The storing unit 220 stores programs and various files. Any storage device can be used as the storing unit 220, for example, a solid state drive (SSD). All or a part of the programs stored in the storing unit 220 is executed by the CPU 211 if the mobile terminal 200 is started. One of the programs stored in the storing unit 220 is a POS application 221. The POS application 221 is application software that causes the mobile terminal 200 to function as a point of sales (POS) terminal.

The ROM 212 stores various programs and various data executed by the CPU 211. The RAM 213 is used for loading a program executed by the CPU 211 and temporarily storing various values. The CPU 211 functions as a control unit 210 by executing the program stored in the ROM 212 or the storing unit 220. By executing the POS application 221 by the CPU 211, the control unit 210 functions as various functional units (see FIG. 4) described below.

FIG. 4 is a diagram illustrating an example of a functional configuration of the mobile terminal 200. The control unit 210, which may include at least one processor, includes an imaging unit 201, a reading unit 202, a registration unit 203, and the like.

The imaging unit 201 controls the camera 218 to acquire the captured image output by the camera 218 and transmits the captured image to the server 100. The reading unit 202 controls the scanner 520 to acquire a commodity code output by the scanner 520 and transmits the commodity code to the server 100. The registration unit 203 registers sales data. That is, the registration unit 203 stores commodity information input from the server 100 in the storing unit 220 as sales data. The commodity information is information received from the server 100 and is uniquely specified by the commodity code acquired by the mobile terminal 200.

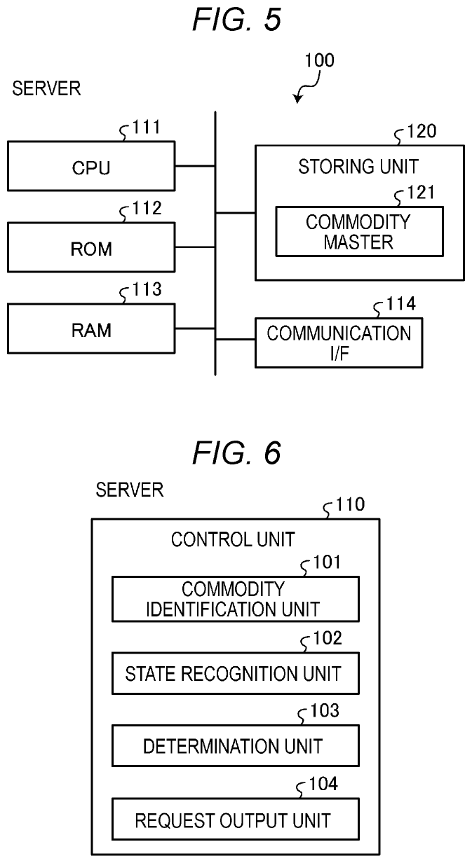

Next, the server 100 will be described. FIG. 5 is a diagram illustrating an example of a hardware configuration of the server 100. The server 100 includes a CPU 111, a ROM 112, a RAM 113, a communication I/F 114, a storing unit 120, and the like. The communication I/F 114 enables communication with an external device, and mediates communication with the mobile terminal 200, the clerk terminal 300, and the like.

The storing unit 120 stores programs and various files. Any storage device can be used as the storing unit 120, for example, a hard disc drive (HDD) or an SSD. All or a part of the programs stored in the storing unit 120 is executed by the CPU 111 if the server 100 is started. One of the files stored in the storing unit 120 is a commodity master 121. The commodity master 121 stores commodity information such as the price and the name (commodity name) in correlation with the commodity code which is an identification code capable of identifying (uniquely specifying) the commodity.

The ROM 112 stores various programs and various data executed by the CPU 111. The RAM 113 is used for loading a program executed by the CPU 111 and temporarily storing various values. The CPU 111 functions as a control unit 110, which may include at least one processor, by executing the program stored in the ROM 112 or the storing unit 120. The control unit 110 includes various functional units (see FIG. 6) described below.

FIG. 6 is a diagram illustrating an example of a functional configuration of the server 100. The control unit 110 includes a commodity identification unit 101, a state recognition unit 102, a determination unit 103, a request output unit 104, and the like.

The commodity identification unit 101 acquires the price and the commodity name from the commodity master 121 using the commodity code input from the mobile terminal 200 as a key, and outputs the price and the commodity name to the mobile terminal 200.

In at least one embodiment, although the commodity is identified based on the commodity code output by the scanner 520 reading the code symbol, the implementation is not limited to this commodity identification, and for example, a generic object recognition (object recognition) technique maybe used to specify the commodity based on feature data of an appearance thereof.

The state recognition unit 102 recognizes a state of an operator of the mobile terminal 200 based on information acquired by the mobile terminal 200. More specifically, the state recognition unit 102 estimates emotion of the operator from a facial expression of the operator included in image information output by the camera 218. The state recognition unit 102 recognizes the state of the operator from voice information output by the microphone 219. This process is performed in parallel with a process performed by the registration unit 203.

The image information output by the camera 218 and the voice information output by the microphone 219 are examples of information acquired by the mobile terminal 200. If the mobile terminal 200 acquires these image information and voice information, the mobile terminal 200 outputs the image information and the voice information to the server 100. If the image information or the voice information is input from the mobile terminal 200 to the server 100, the state recognition unit 102 recognizes the state of the operator of the mobile terminal 200 based on the input information. The state of the operator is, for example, feelings such as dissatisfaction or anger, or a situation in which the customer cannot find a commodity and is searching around.

If image information is input from the mobile terminal 200 to the server 100, the state recognition unit 102 extracts a face image included in the image information, analyzes the face image, and estimates the emotion from the facial expression. Existing techniques may be used for this analysis process. If voice information is input from the mobile terminal 200 to the server 100, the state recognition unit 102 extracts words included in the voice information.

The determination unit 103 determines whether or not support from a clerk is required based on the state of the operator recognized by the state recognition unit 102. For example, if the state recognition unit 102 determines that the operator is dissatisfied, angry, or in trouble, the determination unit 103 determines that the support from a clerk is required.

More specifically, if the information acquired from the mobile terminal 200 is image information, if the emotion estimated from the face image included in the image information is related to, for example, dissatisfaction, anger, embarrassment, and the like, the determination unit 103 determines that the support of the clerk is required. If the information acquired from the mobile terminal 200 is voice information, if there are words related to dissatisfaction or anger, such as “where” or “cannot be found”, among the words contained in the voice information, the determination unit 103 determines that the support of the clerk is required.

If the determination unit 103 determines that the support is required, the request output unit 104 outputs information for requesting the support for the operator to the clerk terminal 300 operated by the clerk. The request output unit 104 includes information capable of identifying the operator in the information for requesting the support. The information capable of identifying the operator includes, for example, a face image.

Furthermore, the request output unit 104 includes information indicating the position of the mobile terminal 200 in the information for requesting the support. The information indicating the position of the mobile terminal 200 is, for example, information for causing an image illustrating a current value of the mobile terminal 200 to be displayed on an in-store map, or a name of a sales floor in the vicinity of the mobile terminal 200.

For example, if the store can be seen from any place in the store due to its size and structure, the information indicating the position of the mobile terminal 200 may not be included therein.

Next, the clerk terminal 300 will be described. FIG. 7 is a diagram illustrating an example of a hardware configuration of the clerk terminal 300. The clerk terminal 300 includes a CPU 311, a ROM 312, a RAM 313, a communication I/F 314, a display unit 315, an operation unit 316, a storing unit 320, and the like.

The display unit 315 is a display device such as an LCD, and displays information to the operator (clerk) of the clerk terminal 300. The operation unit 316 is, for example, a touch panel or the like provided while being overlapped on the display surface of the display unit 315, and receives an input operation to the clerk terminal 300, and outputs information based on the operation. The communication I/F 314 enables communication with an external device and mediates communication with the server 100 and the like.

The storing unit 320 stores programs and various files.

Any storage device can be used as the storing unit 220, for example, a solid state drive (SSD). All or a part of the programs stored in the storing unit 320 is executed by the CPU 311 if the clerk terminal 300 is started.

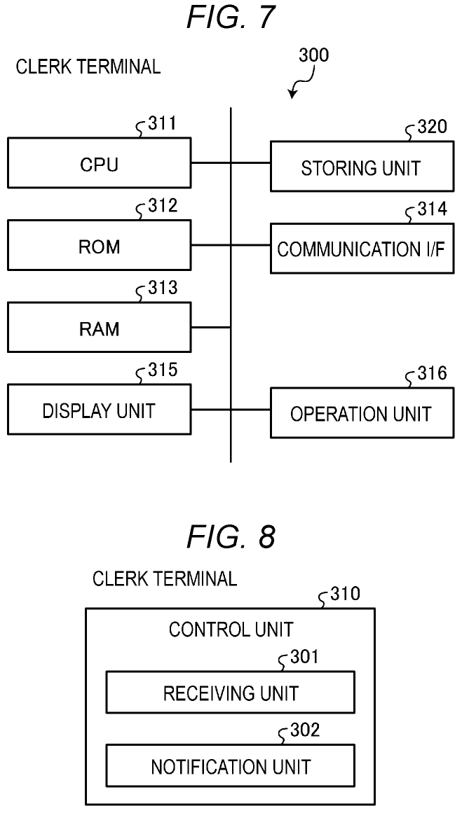

The ROM 312 stores various programs and various data executed by the CPU 311. The RAM 313 is used for loading a program executed by the CPU 311 and temporarily storing various values. The CPU 311 functions as a control unit 310, which may have one or more processors, by executing the program stored in the ROM 312 or the storing unit 320. The control unit 310 includes various functional units (see FIG. 8) described below.

FIG. 8 is a diagram illustrating an example of a functional configuration of the clerk terminal 300. The control unit 310 includes a receiving unit 301, a notification unit 302, and the like.

The receiving unit 301 receives input of various information from the server 100. If the receiving unit 301 receives information for requesting the support for the operator, the notification unit 302 notifies the clerk by displaying the information on the display unit 315 or the like.

If the clerk terminal 300 is provided with a speaker or the like, the clerk who owns the clerk terminal 300 can easily notice the support request if the notification unit 302 emits a voice from the speaker with the notification on the display unit 315.

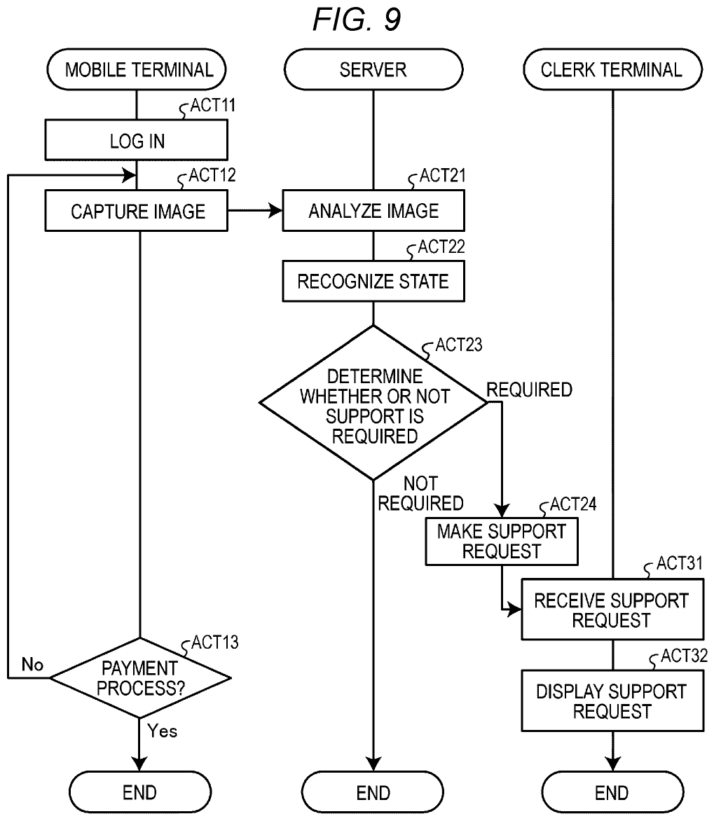

In a sales data processing system having such a configuration, the mobile terminal 200 starts imaging with the camera 218 if the customer who entered the store starts the POS application 221, the server 100 analyzes the captured image output by the camera 218, recognizes the state of the customer, and outputs a support request to the clerk terminal 300 if support is required. A flow of this series of processes will be described in more detail with reference to FIG. 9. FIG. 9 is a diagram schematically illustrating an example of a processing flow of each configuration of the sales data processing system.

First, if the customer who entered the store starts using the mobile terminal 200, the POS application 221 is started on the mobile terminal 200 and asks the customer to log in. The customer logs in by inputting a member ID or the like (ACT 11). The member ID may be input by causing the scanner 520 to read a code symbol such as a barcode or a two-dimensional code displayed on a membership card, or by manually inputting using the operation unit 216.

After logging in, the mobile terminal 200 displays a screen (commodity registration screen) for displaying a list of commodity information registered as sales data on the display unit 215. This screen contains a button instructing the scanner 520 to start reading the code symbol. If the button is operated through the operation unit 216, the scanner 520 starts irradiation and imaging.

In parallel with the sales data processing as described above, the mobile terminal 200 captures an image with the camera 218 (ACT 12) and transmits the captured image to the server 100. The image captured by the camera 218 is not required to be displayed on the display unit 215. The imaging is continued until a payment process is performed on the mobile terminal 200 (No in ACT 13). If the operation unit 216 receives an operation from the operator (customer) to perform payment (Yes in ACT 13), the mobile terminal 200 ends the act of capturing an image and ends this process.

If the captured image is input from the mobile terminal 200, the server 100 analyzes the captured image (ACT 21) and recognizes the state of the customer (ACT 22). Next, the server 100 determines whether or not the support for the customer by the clerk is required based on the state of the customer (ACT 23). If it is determined in ACT 23 that the support is not required, the server 100 ends this process.

If it is determined in ACT 23 that the support is required, the server 100 makes a support request (ACT 24).

If the support request is input from the server 100, the clerk terminal 300 receives the support request (ACT 31), displays the support request on the display unit 315 (ACT 32) , and ends this process.

As described above, according to the sales data processing system of at least one embodiment, the mobile terminal 200 used for registering the commodity to be purchased by the customer collects facial expressions and words of the customer, recognizes the state of the customer, and requests support from the clerk through the clerk terminal 300 as needed. By doing as described above, if a customer moving through the sales floor of a retail store is in a state requiring the support of the clerk, the clerk can be notified of the state and support can be provided.

The mobile terminal 200 moves together with the customer who moves in the store, and if the customer views or operates display contents of the mobile terminal 200, the camera 218 can capture the facial expression of the customer. Therefore, for example, if the customer who grabs the handle portion 513 and pushes the cart POS 500 and walks is in trouble because he or she cannot find a desired commodity, the camera 218 captures the facial expression, and the state recognition unit 102 can analyze the facial expression of the customer to recognize the troubled state of the customer and lead to support from the clerk.

Furthermore, if the microphone 219 captures words of the customer and expressions indicating that the customer are in trouble, and the like are contained in the words, such a state can be recognized, which can lead to the support from the clerk.

In at least one embodiment, the face image and the voice are acquired from the mobile terminal 200 as information used for recognizing the state of the customer, but in the implementation, the state of the customer may be recognized from information other than the face image and voice.

In this embodiment, an example in which the mobile terminal 200 is a tablet terminal is described, but in the implementation, the mobile terminal 200 may be a portable terminal such as a smartphone, for example. The smartphone as the portable terminal may be rented in the store or may be owned by the customer.

In at least one embodiment, an example in which the mobile terminal 200 is a tablet terminal provided in the shopping cart 510 is described, but in the implementation, the mobile terminal 200 may be, for example, a customer terminal such as a smartphone owned by the customer. In this case, for example, a holder for holding the customer terminal is preferably provided in the shopping cart 510. In this case, the customer terminal functions as the mobile terminal of this embodiment by starting installed predetermined application software (corresponding to the POS application 221 in the embodiment). If a smartphone is used as the mobile terminal, the smartphone can also act as the scanner 520 as described below.

The case where the smartphone owned by the customer is used as the mobile terminal will be described in more detail. Many smartphones in recent years are provided with cameras on both a side where a display device is located and a back face side thereof, and such a smartphone can capture an image on both sides of the camera. If such a smartphone is used as the mobile terminal, a holder holds the smartphone with the camera on the back face side of the display device facing the storage portion 511 side. In such a usage pattern, if the customer placing the commodity into the storage portion 511, the customer captures an image of the commodity with the camera on the back face side (rear face camera). The camera (front face camera) on the display device side captures an image of the customer. In this way, the smartphone can be used in place of the mobile terminal 200 and the scanner 520, which are the tablet terminals of at least one embodiment described above.

If the smartphone owned by the customer is used as the mobile terminal, the smartphone, which is the mobile terminal, performs a store entry process instead of the login in ACT 11. The store entry process is, for example, as follows. First, the customer starts (executes) the POS application 221 when entering the store. Next, the customer acquires an access code for wirelessly connecting to the in-store system by causing the camera to read the two-dimensional code displayed at the entrance of the store or the like according to an instruction of the POS application 221. After the store entry process as described above, the POS application 221 starts a commodity registration process.

After the store entry process, the POS application 221 performs the commodity registration process by the back face camera and captures the face image of the customer by the front face camera in parallel with the commodity registration process. In this case, the display device (corresponding to the display unit 215) displays a commodity registration screen.

Furthermore, in at least one embodiment, the mobile terminal 200 transmits the captured image including the face image of the customer to the server 100, and the server 100 performs the process of recognizing the state of the customer, but the implementation is not limited to this process. That is, for example, the mobile terminal 200 may include functional units corresponding to the state recognition unit 102, the determination unit 103, and the request output unit 104 of this embodiment.

In at least one embodiment, the server 100 is described as being a PC installed in, for example, the backroom of a store, but the implementation is not limited to such a PC. For example, the server 100 may be a virtual server in a cloud environment. The virtual server in this case is constructed, for example, in the headquarter server belonging to the headquarter on a per store basis or on a per appropriately configured group basis. In this case, the mobile terminal 200 and the clerk terminal 300 communicate with the virtual server.

The sales data processing system of this embodiment includes a control device such as a CPU, a storage device such as a ROM or a RAM, an external storage device such as an HDD or a CD drive device, a display such as a display device, and an input device such as a keyboard and a mouse, and has a hardware configuration using a general purpose computer.

The program executed by the sales data processing system of this embodiment is provided by being incorporated in the storage device such as the ROM in advance.

For example, a configuration in which the program executed by the sales data processing system of this embodiment is provided by being recorded on a computer-readable recording medium such as a CD-ROM, a flexible disc (FD), a CD-R, or a digital versatile disk (DVD) in a file of an installable or executable format may be adopted.

Furthermore, a configuration in which the program executed by the sales data processing system of at least one embodiment is stored on a computer connected to a network such as the Internet and provided by downloading via the network maybe adopted. A configuration in which the program executed by the sales data processing system of at least one embodiment is provided or distributed via a network such as the Internet may be adopted.

The program executed by the sales data processing system of this embodiment has a modular configuration including the units described above (commodity identification unit 101, state recognition unit 102, determination unit 103, request output unit 104, imaging unit 201, reading unit 202, registration unit 203, receiving unit 301, notification unit 302, and the like). The CPU (processor) reads each program from the storage device and executes the program to load each unit described above on a main memory device. With this configuration, the commodity identification unit 101, the state recognition unit 102, the determination unit 103, the request output unit 104, the imaging unit 201, the reading unit 202, the registration unit 203, the receiving unit 301, and the notification unit 302 are generated on the main memory device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A sales data processing system comprising:
at least one memory; and
at least one processor configured to:
register information of a commodity specified by information acquired by a mobile terminal as sales data;
recognize a state of an operator of the mobile terminal based on the information acquired by the mobile terminal, in parallel with a registration process by the at least one processor;
determine whether support from a clerk is required, based on the state of the operator recognized; and
output information for requesting support for the operator to a clerk terminal operated by the clerk, when it is determined that the support is required.

2. The system according to claim 1, wherein
the mobile terminal includes a camera configured to capture an image of a side facing a display that displays information toward the operator of the mobile terminal or a processor of the mobile terminal that receives an operation on the mobile terminal, and
the at least one processor is configured to estimate emotion of the operator from a facial expression of the operator included in image information output by the camera.

3. The system according to claim 1, wherein
the mobile terminal includes a microphone, and
the at least one processor is configured to recognize a state of the operator from voice information output by the microphone.

4. The system according to claim 1, wherein
the at least one processor is configured to store, in the at least one memory, information specifying the operator in the information for requesting the support.

5. The system according to claim 1, wherein
the at least one processor is configured to store, in the at least one memory, information indicating a position of the mobile terminal in the information for requesting the support.

6. A method for causing a computer of a sales data processing system to perform:
registering information of a commodity specified by information acquired by a mobile terminal as sales data;
recognizing a state of an operator of the mobile terminal based on the information acquired by the mobile terminal, in parallel with a process in the registering;
determining whether support from a clerk is required, based on the state of the operator recognized in the recognizing the state; and
outputting information for requesting support for the operator to a clerk terminal operated by the clerk, when it is determined, in the determining, that the support is required.

7. The system according to claim 1, wherein the at least one processor comprises a server.

8. The system according to claim 1, wherein the information acquired by the mobile terminal includes voice information of the operator.

9. The system according to claim 1, wherein the clerk terminal includes a smart phone.

10. The system according to claim 1, wherein the estimated emotion includes at least one of dissatisfaction, anger, or embarrassment.

11. The system according to claim 4, wherein the information specifying the operator includes face image data.

12. The system according to claim 4, wherein the information specifying the operator includes a position of the mobile terminal.

13. The method according to claim 6, wherein the information acquired by the mobile terminal includes voice information of the operator.

14. The method according to claim 6, wherein the information for requesting the support includes information specifying the operator.

15. The method according to claim 14, wherein the information specifying the operator includes face image data.

16. The method according to claim 14, wherein the information specifying the operator includes a position of the mobile terminal.
